(19) United States
(12) Patent Application Publication
(10) Pub. No.: US 2010/0117927 A1
(43) Pub. Date: May 13, 2010

(54) Dual-Display Computer

(76) Inventors: Atsuhiko Amagami, Tokyo (JP); Kenichi Kurumiya, Sagamihara-Shi (JP)

Correspondence Address: DILLON & YUDELL LLP, 8911 N. CAPITAL OF TEXAS HWY, SUITE 2110, AUSTIN, TX, 78759, US

(21) Appl. No.: 12/604,001

(22) Filed: Oct. 22, 2009

(30) Foreign Application Priority Data
Nov. 13, 2008 (JP) 2008-290939

(51) Int. Cl. G09G 5/00; G06F 1/16

(52) U.S. Cl. 345/1.1; 361/679.26

(57) ABSTRACT

A portable computer having a primary and secondary displays is disclosed. The portable computer includes a step value storage device for storing a set of manipulation step values for simultaneously controlling the luminance of the primary and secondary displays. The portable computer also includes a first luminance table and a second luminance table. The first luminance table stores a set of first control step values that corresponds to a luminance value to be set to the primary display for each of the manipulation step values. The second luminance table stores a set of second control step values that corresponds to a luminance value to be set to the secondary display for each of the manipulation step values so that the luminance values set for the secondary display becomes substantially identical to the luminance values set for the primary display within a range of a predetermined number of consecutive manipulation step values.

### PRIORITY CLAIM

The present application claims benefit of priority under 35 U.S.C. §§120, 365 to the previously filed Japanese Patent Application No. JP2008-290939 entitled, “Dual Display Computer” with a priority date of Nov. 13, 2008, which is incorporated by reference herein.

### BACKGROUND

1. Technical Field

The present invention relates to portable computers in general, and in particular to a portable computer equipped with two displays.

2. Description of Related Art

A notebook personal computer (notebook PC) has excellent portability because of its light weight and small size. A notebook PC is also able to realize functions equivalent to a desktop computer via a function extending apparatus such as a docking station or a port replicator.

Since a notebook PC is equipped with only one display, in order to use two or more displays, it is necessary to connect an external display thereto via a function extending apparatus or connect the external display to an external terminal. When the user works with many windows concurrently opened on one display, the user may have to resize the various overlapping windows in order to view all the windows at once.

### SUMMARY

In order to improve work efficiency, it would be desirable for a notebook PC display to distribute and display the various windows on multiple displays. In addition, since the display luminance of the notebook PC is adjustable by a user according to the place of use, it would be desirable to be able to adjust the luminance with a simple manipulation when multiple displays are mounted on the notebook PC.

In accordance with a preferred embodiment, a notebook PC includes a to primary display and a secondary display. The notebook PC also includes a step value storage device for storing a set of manipulation step values for simultaneously controlling the luminance of the primary and secondary displays. The notebook PC further includes a first luminance table and a second luminance table. The first luminance table stores a set of first control step values that corresponds to a luminance value to be set to the primary display for each of the manipulation step values. The second luminance table stores a set of second control step values that corresponds to a luminance value to be set to the secondary display for each of the manipulation step values so that the luminance values set for the secondary display becomes substantially identical to the luminance values set for the primary display within a range of a predetermined number of consecutive manipulation step values.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIGS. 1A and 1B are perspective views of an outer appearance of a notebook PC in accordance with a preferred embodiment;

FIG. 2 is a block diagram of a notebook PC, in accordance with a preferred embodiment;

FIG. 3 is a block diagram illustrating the connection between a graphic processing unit mounted on a graphics card and a primary display as well as a secondary display;

FIG. 4 is a block diagram illustrating the configuration of the software and hardware components mounted on the notebook PC from FIG. 2, for performing a luminance adjustment;

FIG. 5A and 5B are views for describing the data structure of a luminance table;

FIGS. 6A and 6B are graphs illustrating the relationship between the manipulation step values and the luminance values of the luminance table as a luminance curve; and

FIG. 7 is a high-level logic flow diagram of a method for simultaneously controlling the luminance values of the primary display and the secondary display of the notebook computer from FIG. 2.

### DETAILED DESCRIPTION OF A PREFERRED EMBODIMENT

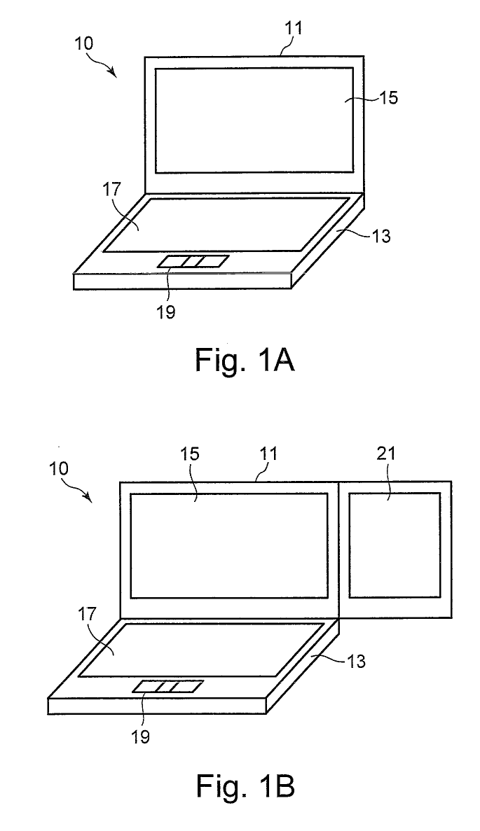

Referring now to the drawings and in particular to FIGS. 1A to 1D, there are depicted the outer appearances of a notebook PC 10 in accordance with a preferred embodiment. The notebook PC 10 includes a display casing 11 and a system casing 13. The display casing 11 is coupled to the system casing 13 via a hinge. The notebook PC 10 also includes a primary display 15 and a secondary display 21, both being integrated within the display casing 11. FIG. 1A illustrates a state where only the primary display 15 is being used, and FIG. 1B illustrates a state where the secondary display 21 is exposed, and both the primary display 15 and the secondary display 21 are being used simultaneously.

The display casing 11 accommodates therein the primary display 15 so that a displaying surface faces the front side when the display casing 11 is opened from the system casing 13, and at the same time, the secondary display 21 is drawably accommodated on a backside. When the secondary display 21 is needed, the secondary display 21 can be drawn out of the display casing 11, and the displaying surface of the secondary display 21 is set to face the same direction as the primary display 15. The system casing 13 accommodates therein various types of functional devices. A keyboard 17 and a pointing device 19 are mounted on the system casing 13.

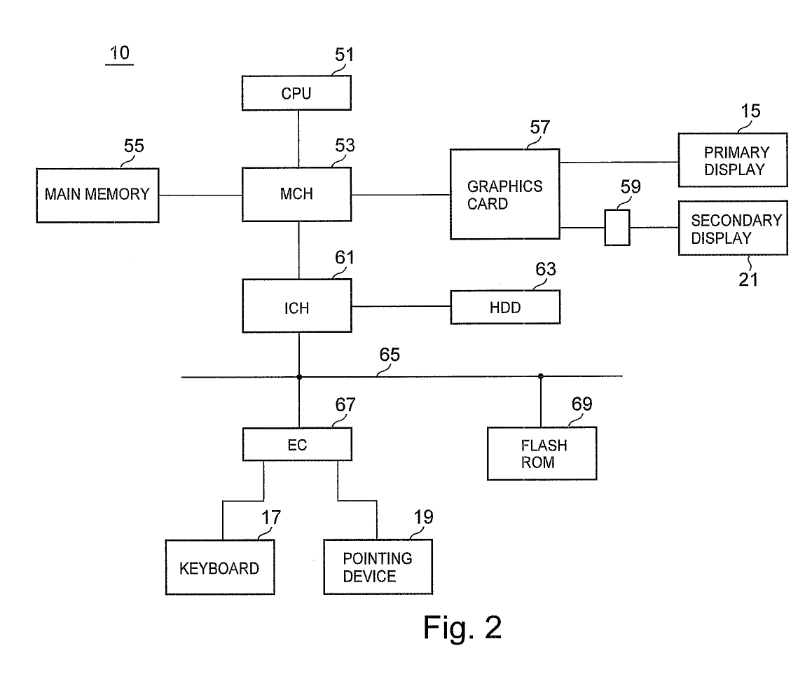

FIG. 2 is a block diagram of the notebook PC 10. A computer processing unit (CPU) 51 is an arithmetic processing device performing the central function of the notebook PC 10, which includes the execution of an operating system (OS), various device drivers and various application programs. The CPU 51 is connected to a memory controller hub (MCH) 53. The MCH 53 is a device that processes high-speed data transfer within the notebook PC 10. The MCH 52 has a memory controller for controlling an operation of accessing a main memory 55, a data buffer for absorbing a difference in a data transfer rate between the CPU 51 and other devices. The MCH 51 is equipped with a PCI Express x16 port for connecting a graphics card 57 thereto.

The main memory 55 is a volatile random access memory (RAM) that is used as a read area of programs executed by the CPU 51 and a work area to which processed data are written. The graphics card 57 is connected to the MCH 53 and is provided with a graphic processing unit (GPU), a video BIOS, and a video memory (VRAM), and is configured to receive a drawing command from the CPU 51 to produce images of image files and write the images in the VRAM and to output images read out of the VRAM at predetermined timing to the primary display 15 and the secondary display 21. The GPU is a special processor exclusively for writing images to the VRAM in accordance with the drawing command received from the CPU 51 and is also referred to as a graphics accelerator. The graphics card 57 is connected to the primary display 15 and a protocol converter 59. The protocol converter 59 is connected to the secondary display 21.

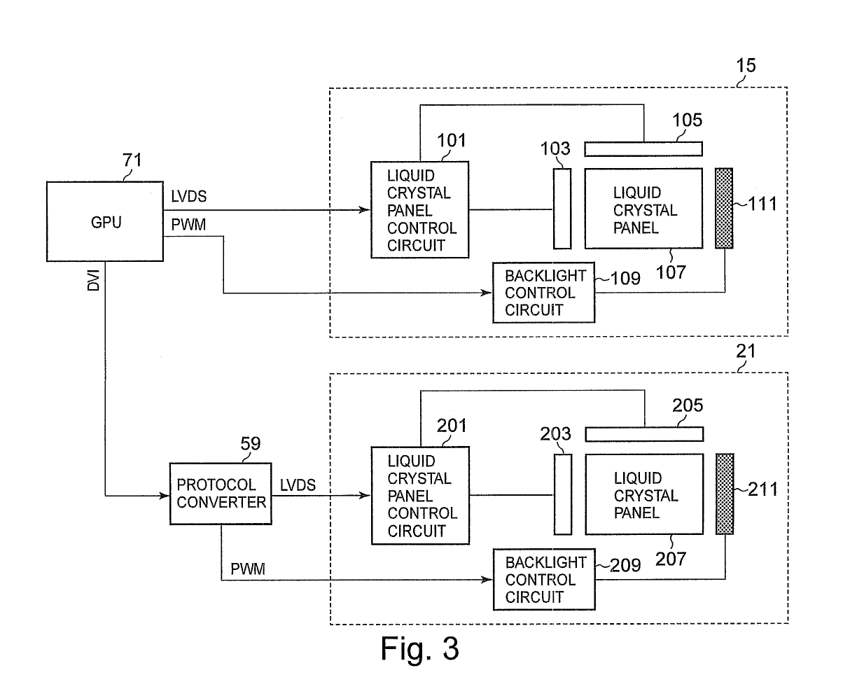

FIG. 3 is a block diagram illustrating the connection between a GPU 71 mounted on the graphics card 57 and the primary display 15 along with the secondary display 21. The GPU 71 is capable of outputting image data of two systems: one of a primary system associated to the primary display 15; and the other of a secondary system associated to the secondary display 21. The GPU 71 receives, from the CPU 51, a first control step value for controlling the luminance of the primary display 15, and a second control step value for controlling the luminance of the secondary display 21. The detailed description of the control step values will be described below. The primary system is configured to output an image signal compliant with the low voltage differential signaling (LVDS) format and a PWM signal for controlling a backlight 111 to the primary display 15. The duty ratio of the PWM signal corresponds to the first control step value. The secondary system is configured to output an image signal compliant with the digital visual interface (DVI) format. However, for the present embodiment, the format of the image signal output by the GPU 71 is not limited to LVDS or DVI.

The protocol converter 59 is configured to convert the image signal compliant with the DVI format received from the GPU 71 into an image signal compliant with the LVDS format and output the converted image signal to the secondary display 21. The GPU 71 is also configured to transfer the second control step value received from the CPU 51 to the protocol converter 59 via a DDC channel, which is a portion of a DVI signal line. The protocol converter 59 is configured to generate a PWM signal having a duty ratio that corresponds to the second control step value and to output the PWM signal to the secondary display 21, thereby controlling the backlight 211.

The primary display 15 and the secondary display 21 have substantially the same structure; i.e., they are configured to include liquid crystal panels 107 and 207, backlights 111 and 211, data line-driving circuits 105 and 205, a scanning line-driving circuits 103 and 203, liquid crystal panel control circuits 101 and 201, and backlight control circuits 109 and 209, respectively. The liquid crystal panels 107 and 207 employ an active matrix mode, in which each cell of a liquid crystal array constituting each pixel includes a thin film transistor (TFT), a pixel capacitor, and a storage capacitor.

The backlight 111 is a side-edge type backlight that uses a cold cathode fluorescent lamp (CCFL) as a light source, and the backlight 211 is a side-edge type backlight that uses a light-emitting diode (LED) as a light source. The side-edge type backlight can make a liquid crystal display thinner than a direct-type backlight, and the secondary display 21 can achieve a much thinner display because it uses LEDs as a light source. The backlight control circuit 109 is configured to control a voltage applied to the backlight 111, with the duty ratio of the PWM signal received from the GPU 71, so as to control the luminance of the liquid crystal panel 107. The backlight control circuit 209 is configured to control a current applied to the backlight 211, with the duty ratio of the PWM signal received from the protocol converter 59, so as to control the luminance of the liquid crystal panel 207. The GPU 71 and the protocol converter 59 are configured to set a duty ratio of 0 to 100% in order to correspond to the 256 values of the first or second control step values.

The liquid crystal panel control circuits 101 and 201 are configured to receive, from the GPU 71, image data of red, green, and blue for displaying images on the liquid crystal panels 107 and 207, respectively, to generate and output image data that are serial by the time axis to the data line-driving circuits 105 and 205 and the scanning line-driving circuits 103 and 203, respectively. The data line-driving circuits 105 and 205 and the scanning line-driving circuits 103 and 203 are configured to perform a line-sequential scanning of the TFTs of the liquid crystal array every one-frame period to sequentially write serial image data to pixel capacitors, thereby displaying two-dimensional images on the liquid crystal panels 107 and 207, respectively.

Referring back to FIG. 2, an I/O controller hub (ICH) 61 is connected to the MCH 53 in order to process a data transfer to/from peripheral input/output devices. The ICH 61 is provided with ports for a Universal Serial Bus (USB), a serial ATA (AT Attachment), a Serial Peripheral Interface (SPI) bus, a Peripheral Component Interconnect (PCI) bus, a PCI-Express bus, a Low Pin Count (LPC), and the like, and is connected to devices corresponding thereto. In FIG. 2, only an HDD 63 connected to a serial ATA port of the ICH 61 is illustrated, and other devices are not illustrated.

The ICH 61 is also connected via an LPC bus 65 to legacy devices, which in the past have been used in notebook PCs 10, or devices which do not require high-speed data transfer. In FIG. 2, only an embedded controller (EC) 67 and a flash ROM 69 are illustrated as the devices connected to the LPC bus 65. The EC 67 is a microcomputer configured by an 8- to 16-bit CPU, a ROM, a RAM, and the like, and is further provided with an multi-channel A/D input terminal, a multi-channel D/A output terminal, a timer, and a digital input/output terminal. The EC 67 controls the electric power supplied to the devices mounted on the notebook PC 10. The EC 67 mounts thereon a keyboard controller function and is connected to the keyboard 17 and the pointing device 19.

The flash ROM 69 is a non-volatile memory in which the stored contents are electrically rewritable, and which stores therein a device driver for controlling the input/output device, a system BIOS for managing power, the temperature of the system casing 13, or the like, so as to comply with the Advanced Configuration and Power Interface (ACPI) specifications, a Power-On Self Test (POST) for performing tests or initialization of hardware components during activation of the notebook PC 10, and the like.

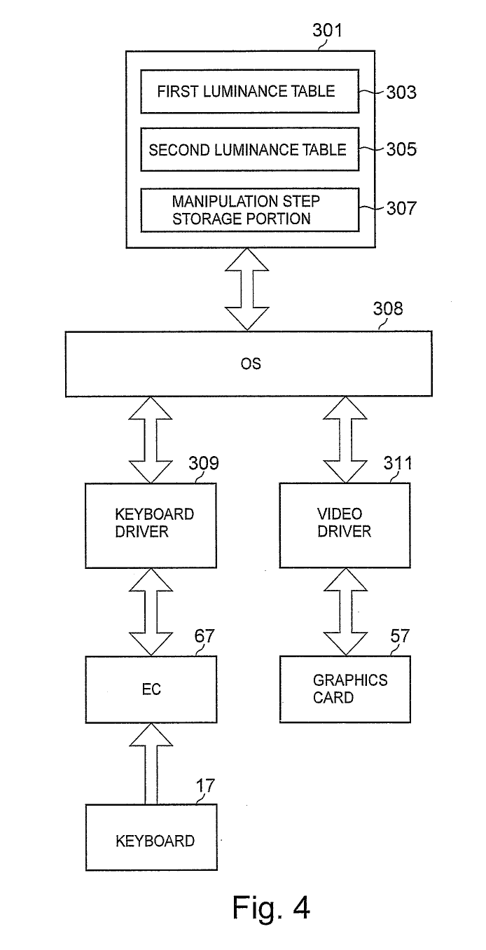

FIG. 4 is a block diagram illustrating the configuration of the software and hardware components mounted on the notebook PC 10, for performing a luminance adjustment in accordance with a preferred embodiment. A utility program 301 is an application program that runs on the OS 308, and performs processing related to the adjustment of the luminance of the displays. The utility program 301 includes a luminance table 303 for the primary display 15, a luminance table 305 for the secondary display 21, and a control step storage portion 307. The luminance tables 303 and 305 may be combined in one table. The control step storage portion 307 stores therein 16 manipulation step values, from 0 to 15, for controlling the luminance of the primary display 15 and the secondary display 21.

A user is able to select one of the manipulation step values by sequentially increasing or decreasing them through keyboard manipulations while visually checking the results of selecting operations on the display. In the present embodiment, a user selects the manipulation step value by manipulating a special key on the keyboard 17, thereby being able to simultaneously control the luminance of the primary display 15 and the secondary display 21 by one step each time. The special key may be configured by a combination of Fn key and Home key, which can be simultaneously depressed to achieve a luminance increase, along with a combination of Fn key and End key, which can be simultaneously depressed to achieve a luminance decrease. Whatever the special key on the keyboard 17 is depressed once, the present manipulation step value of the control step storage portion 307 is increased or decreased by one step. A keyboard driver 309 is configured to set the parameters to the keyboard controller of the EC 67 or transfer a scan code to the CPU 51.

A video driver 311 is configured to set the parameters to the graphics card 57 or transfer the drawing command from the CPU 51 to the GPU 71.

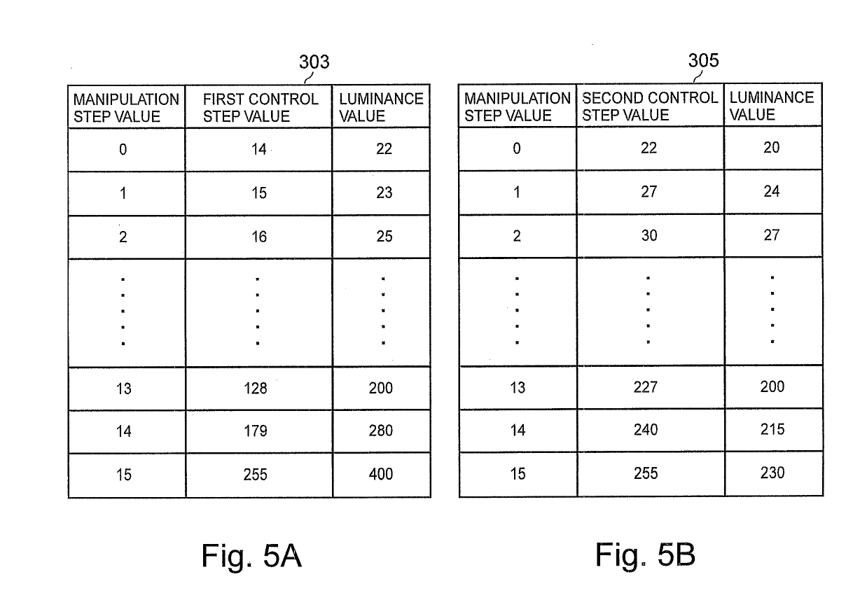

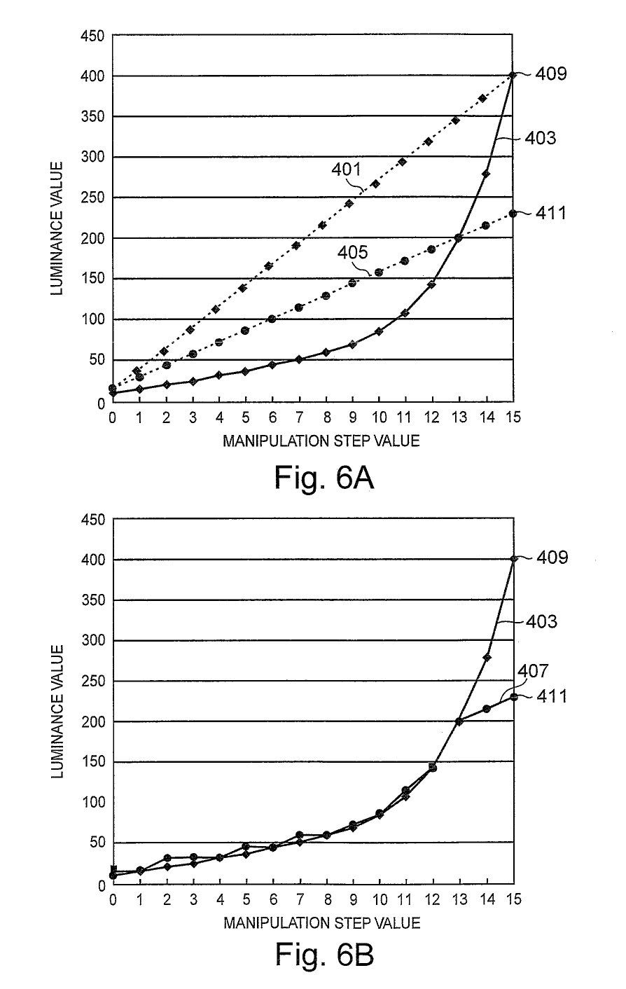

FIGS. 5A and 5B are views for describing the data structures of the luminance tables 303 and 305. FIGS. 6A and 6B are graphs illustrating the relationship between the manipulation step values and the luminance values of the luminance tables 303 and 305 as a luminance curve. The luminance tables 303 and 305 are mapping tables that correlate (map) the manipulation step values and the control step values with each other. In other words, the luminance tables 303 and 305 can be said to map the manipulation step values into luminance values via the control step values. The luminance tables 303 and 305 store therein the first control step values and the second control step values corresponding to 16 manipulation step values from 0 to 15, respectively. The first control step values and the second control step values are constructed by 256 control information data from 0 to 255, respectively. The first control step values are control information data that determine the duty ratio of the PWM signal supplied to the backlight control circuit 109 and correspond to the luminance of the liquid crystal panel 107. The second control step values are the control information data that determine the duty ratio of the PWM signal supplied to the backlight control circuit 209 and correspond to the luminance of the liquid crystal panel 207.

The backlight 111 and the backlight 211 control the luminance of the liquid crystal panels 107 and 207 based on the duty ratio of the voltage or current corresponding to the PWM signal output from the backlight control circuits 109 and 209, respectively. The luminance of the liquid crystal panels 107 and 207 becomes 0 when the duty ratio of the backlight control circuits 109 and 209 is 0%, and, when the duty ratio is 100%, the luminance becomes the maximum that is determined based on the performance of the backlights 111 and 211. In the luminance tables 303 and 305, the first control step value is set to 14 and the second control step value is set to 22 so that the respective displays have the minimum luminance where the respective displays can display images with a predetermined luminance even when the manipulation step value is set to the minimum, namely 0. Moreover, in the luminance tables 303 and 305, the first control step value and the second control step value are set such that, when the manipulation step value is set to the maximum, namely 15, the respective displays have the maximum luminance under the 100% duty ratio of the PWM signal.

The line 401 in FIG. 6A represents a luminance curve of the primary display 15, formed by luminance values corresponding to respective manipulation step values when the manipulation step values from 0 to 15 and the first control step values from 0 to 255 were evenly mapped. Moreover, the line 405 represents a luminance curve of the secondary display 21, formed by luminance values corresponding to respective manipulation step values when the manipulation step values of 0 to 15 and the second control step values of 0 to 255 were evenly mapped. When the manipulation step values and the control step values were evenly mapped, the luminance values of both the primary display 15 and the secondary display 21 increase substantially linearly with an increase in the manipulation step value. In other words, since the control step value is proportional to the duty ratio of the PWM signal, it can be said that the luminance values are also proportional to the duty ratio. However, in the present embodiment, when the luminance tables 303 and 305 are generated, the luminance values corresponding to the respective manipulation step values are determined in advance and the control step values are set so as to correspond to the luminance values. Therefore, it is not necessary that the duty ratio of the PWM signal and the luminance values are proportional to each other or in a specific relation.

The line 403 represent a luminance curve of the primary display 15 that is based on the first control step values corresponding to the respective manipulation step values. In the case of the line 403, the luminance values are increasing exponentially with an increase in the manipulation step value. The shape of the line 403 is determined such that a change in luminance with a change of one step value, detected by the user becomes as even as possible from an ergonomic perspective based on the relationship between the change in luminance detected by the user and the absolute value of the luminance or such that the luminance for each step is determined or optimized from the viewpoint of a balance between the luminance and the power consumption.

In FIG. 6B, the line 407 is a luminance curve of the secondary display 21 which is based on the second control step values corresponding to the respective manipulation step values. In the present embodiment, in place of the line 405, the line 407 is employed as the luminance curve of the secondary display 21. In the example of FIG. 6B, the maximum luminance value 409 of the line 403 is 400, and the maximum luminance value 411 of the line 407 is 230. The first control step values corresponding to the luminance values of the line 403 are stored in the luminance table 303, and the second control step values corresponding to the luminance values of the line 407 are stored in the luminance table 305. The second control step values are set so that the luminance value of the primary display 15 and the luminance value of the secondary display 21 are as identical as possible within a range of consecutive manipulation step values. Although the luminance values corresponding to the control step values are stored in the luminance tables 303 and 305, it is not always necessary to store these luminance values since they are not used for controlling the luminance.

The relationship between the manipulation step value and the control step value will be described by the luminance curve. In the present embodiment, the second control step values are set so that the luminance curve 403 and the luminance curve 407 are as identical as possible within a range of consecutive manipulation step values. The maximum luminance value 411 of the secondary display 21 at the maximum manipulation step value 15 is smaller than the maximum luminance value 409 of the primary display 15. Therefore, the second control step values are set so that the luminance curve 407 becomes identical to the luminance curve 403 until the manipulation step value of 13 representing the intermediate luminance value which is substantially the intermediate value of the luminance in the line 403, and the second control step value is also set so that the luminance curve 407 becomes identical to the line 405 at the manipulation step values of 14 and 15.

In FIGS. 6A and 6B, although the luminance values of the lines 403 and 407 are slightly different within the range of manipulation step values 0 to 13, this difference is small enough to be compared with the quantization error of the control step value when the manipulation step values and the control step values are mapped. Moreover, the difference falls within such a range that the different luminance values are perceived equal by the sensibility of the user. The luminance values of the primary display 15 and the secondary display 21 can be made identical to each other over the entire range of the manipulation step values if the maximum luminance value 409 of the line 403 is identical to the maximum luminance value 411 of the line 405. Since the primary display 15 and the secondary display 21 mounted on the notebook PC 10 have different purposes of use, the secondary display 21 is typically configured with the smaller maximum luminance value. In this case, therefore, the second control step values are set so that the line 405 of the secondary display 21 becomes identical to the line 403 of the primary display 15 within as wide a range as possible of the manipulation step values. This is because, as described above, the line 403 is set to have the optimum shape from the ergonomic and power-saving perspectives.

When the maximum luminance value of the secondary display 21 is larger than the maximum luminance value of the primary display 15, it is possible to make the luminance value of the secondary display 21 identical to the luminance value of the primary display 15 over the entire range of the manipulation step values. When the maximum luminance value 411 of the line 405 is smaller than the maximum luminance value 409 of the line 403 as in FIGS. 6A and 6B, both luminance values can be made identical to each other until the luminance value of the line 403 at a certain manipulation step value (in this case, the manipulation step value of 14) exceeds the maximum luminance value 411 of the line 405.

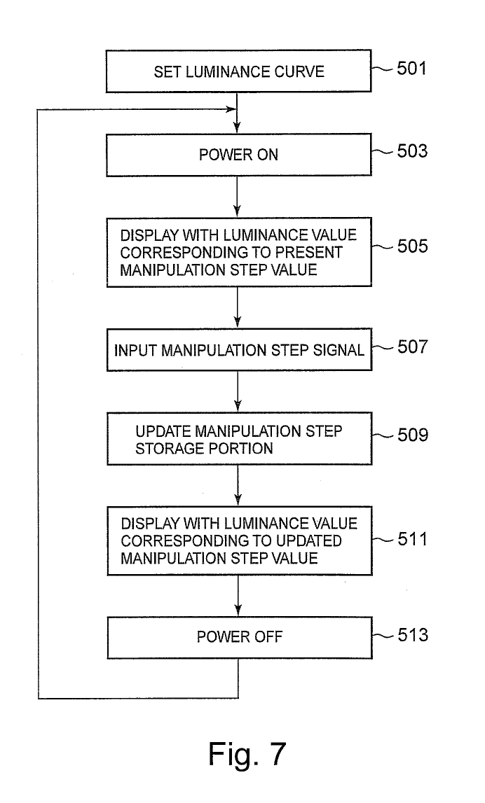

Referring now to FIG. 7, there is illustrated a high-level logic flow diagram of a method for simultaneously controlling the luminance values of the primary display 15 and the secondary display 21 via the manipulation of a special key. In block 501, in the luminance table 303 and the luminance table 305, the first control step values and the second control step values, corresponding to the luminance values of the line 403 from FIG. 6A and the line 407 from FIG. 6B, are stored in advance so as to correspond to the manipulation step values of 0 to 15, respectively. Moreover, the previous manipulation step value immediately before the notebook PC 10 is powered off was held in the control step storage portion 307.

When the notebook PC 10 is started in block 503, the software illustrated in FIG. 4 is loaded into the main memory 55 from the HDD 63. In block 505, the utility program 301 refers to the luminance tables 303 and 305 and the present manipulation step value stored in the control step storage portion 307 to acquire the first control step value of the primary display 15 and the second control step value of the secondary display 21 corresponding to the present manipulation step value, respectively.

The utility program 301 sets the first control step value and the second control step value to the GPU 71 through intervention of the OS 308 and the video driver 311. The GPU 71 generates a PWM signal of a duty ratio corresponding to the first control step value to control the output voltage of the backlight control circuit 109. The backlight 111 performs lighting with a luminance corresponding to the duty ratio of the PWM signal under the control of the backlight control circuit 109. Moreover, the GPU 71 sets the second control step value of the secondary display 21 to the protocol converter 59 using the DDC channel of the DVI signal. The protocol converter 59 generates a PWM signal of the duty ratio corresponding to the second control step value to control the output current of the backlight control circuit 209. The backlight 211 performs lighting with a luminance corresponding to the duty ratio of the PWM signal under the control of the backlight control circuit 209.

In block 507, when a user presses the special key on the keyboard 17, corresponding scan codes are generated by the EC 67 and the keyboard driver 309 interrupts the CPU 51 to transfer the scan codes. In block 509, the CPU 51 analyzes the scan codes and executes the utility program 301, whereby the manipulation step value stored in the control step storage portion 307 is increased or decreased by one step each time by an amount corresponding to the number of key depressions. In block 511, whenever the present manipulation step value stored in the control step storage portion 307 is selected, the utility program 301 refers to the luminance tables 303 and 305 to acquire and transfer to the GPU 71, the first control step value and the second control step value corresponding to the newly selected manipulation step value. When the notebook PC 10 is powered off in block 513, since the state of the control step storage portion 307 immediately before powering-off is stored in the HDD 63, at the next powering-on time, the display will initially display with a luminance based on the stored manipulation step value.

Thereafter, by the same procedures as shown in block 505, the backlight 111 and the backlight 211 will perform lighting with the luminance corresponding to the changed manipulation step value. Here, when the present manipulation step value is changed, the utility program 301 may display the present step value after a change in the primary display 15. In accordance with the present embodiment, it is possible to simultaneously control the luminance of the primary display 15 and the secondary display 21 by a common key manipulation, and the luminance values of both displays are substantially identical to each other in a predetermined range of the luminance curves 403 and 407.

Although the notebook PC of the present embodiment is able to simultaneously control two displays by a common key manipulation, according to the results of a sample test conducted to estimate the luminance of mass-produced notebook

PCs, the respective displays showed variations in their initial luminance and different rates of decrease in the luminance with time. Therefore, verification needs to be made as to whether the typical values of the first control step value and the second control step value, which are set to the primary display 15 and the secondary display 21, respectively, are commonly applicable to all the mass-produced notebook PCs. The notebook PC provides a different display luminance when the luminance is sensed by the user within the range of viewing angles. In accordance with the present embodiment, it was confirmed that no particular discomfort was caused because the difference in the luminance of the two displays is small enough to be allowable within the range of viewing angles even when the luminance values are simultaneously controlled by a common manipulation, and because the difference falls within the range of variations of the luminance when the display was used to its usable limit life.

As has been described, the present invention provides a portable computer having a primary display and a secondary display, and a method for simultaneously controlling the luminance values of the primary display and the secondary display of the portable computer.

It is also important to note that although the present invention has been described in the context of a computer system, those skilled in the art will appreciate that the method of the present invention is capable of being distributed as a computer program product via a computer readable medium such as a compact disc.

While the invention has been particularly shown and described with reference to a preferred embodiment, it will be understood by those skilled in the art that various changes in form and detail may be made therein without departing from the spirit and scope of the invention.

What is claimed is:

1. A portable computer comprising:
a primary display and a secondary display;
a step value storage device for storing a plurality of manipulation step values for simultaneously controlling a luminance of said primary display and a luminance of said secondary display;
a first luminance table for storing a plurality of first control step values that corresponds to a luminance value to be set to said primary display for each of said manipulation step values; and
a second luminance table for storing a plurality of second control step values that corresponds to a luminance value to be set to said secondary display for each of said manipulation step values so that said luminance values set for said secondary display becomes substantially identical to said luminance values set for said primary display within a range of a predetermined number of consecutive manipulation step values.

2. The portable computer of claim 1, wherein said primary display is secured to a display casing, and said secondary display is drawably accommodated on a backside of said display casing.

3. The portable computer of claim 1, wherein said portable computer further includes a graphics card for controlling a backlight of each of said displays by referring to one of said manipulation step values and said first and second luminance tables.

4. The portable computer of claim 1, wherein said backlight of said primary display includes fluorescent tubes and said backlight of said secondary display includes light-emitting diodes.

5. The portable computer of claim 1, wherein said portable computer further includes a primary system configured to output an image signal compliant with a low-voltage differential signaling (LVDS) format and a PWM signal for controlling a backlight to said primary display.

6. The portable computer of claim 5, wherein a duty ratio of said PWM signal corresponds to said first control step value.

7. The portable computer of claim 1, wherein said portable computer further includes a secondary system configured to output an image signal compliant with a digital visual interface (DVI) format to said second display.

8. The portable computer of claim 1, wherein said luminance values corresponding to said first control step values and said luminance values corresponding to said second control step values have regions where the respective luminance values increase exponentially with an increase in said manipulation step value.

9. The portable computer of claim 1, wherein a maximum luminance value of said secondary display is smaller than a maximum luminance value of said primary display, and said luminance values corresponding to said first control step values and said luminance values corresponding to said second control step values are substantially identical to each other within a range from a minimum luminance value to an intermediate luminance value of said primary display.

10. A method comprising:
providing a portable computer with a plurality of manipulation step values for simultaneously controlling a luminance of a primary display and a luminance of a secondary display of said portable computer;
storing in said portable computer control information capable of making a luminance of said primary display and a luminance of said secondary display substantially identical to each other with respect to each of a plurality of consecutive manipulation step values;
in response to a manipulation step signal input from a user, selecting a manipulation step value to simultaneously control said luminance of said primary display and said luminance of said secondary display; and
controlling a backlight of said primary display and a backlight of said secondary display based on a control information corresponding to said selected manipulation step value.

11. The method of claim 10, wherein said storing further includes storing a first luminance curve to provide said luminance of said primary display and a second luminance curve to provide said luminance of said secondary display for each of said manipulation step values in which said first luminance curve and said second luminance curve are configured so that said luminance values of the respective displays are substantially identical to each other within a predetermined number of consecutive manipulation step values.

12. The method of claim 10, wherein a maximum luminance value of said secondary display is smaller than a maximum luminance value of said primary display, and that said luminance values corresponding to said first control step values and said luminance values corresponding to said second control step values are substantially identical to each other within a range from said minimum luminance value to an intermediate luminance value of said primary display.

13. A computer usable medium having a computer program product for controlling the luminance values of displays of a portable computer, said computer usable medium comprising:
computer program code for providing a portable computer with a plurality of manipulation step values for simultaneously controlling a luminance of a primary display and a luminance of a secondary display of said portable computer;
computer program code for storing in said portable computer control information capable of making a luminance of said primary display and a luminance of said secondary display substantially identical to each other with respect to each of a plurality of consecutive manipulation step values;
computer program code for, in response to a manipulation step signal input from a user, selecting a manipulation step value to simultaneously control said luminance of said primary display and said luminance of said secondary display; and
computer program code for controlling a backlight of said primary display and a backlight of said secondary display based on a control information corresponding to said selected manipulation step value.

14. The computer usable medium of claim 13, wherein said computer program code for storing further includes computer program code for storing a first luminance curve to provide said luminance of said primary display and a second luminance curve to provide said luminance of said secondary display for each of said manipulation step values in which said first luminance curve and said second luminance curve are configured so that said luminance values of the respective displays are substantially identical to each other within a predetermined number of consecutive manipulation step values.

15. The computer usable medium of claim 13, wherein a maximum luminance value of said secondary display is smaller than a maximum luminance value of said primary display, and that said luminance values corresponding to said first control step values and said luminance values corresponding to said second control step values are substantially identical to each other within a range from said minimum luminance value to an intermediate luminance value of said primary display.
